(19) United States
(12) Patent Application Publication
(10) Pub. No.: US 2025/0092922 A1
(43) Pub. Date: Mar. 20, 2025

(54) DRIVETRAIN COMPONENT INCLUDING AN ELECTROMAGNETIC ACTUATOR WITH INTEGRATED WIRE CONNECTION

(71) Applicant: GKN Automotive Limited, Birmingham (GB)

(72) Inventor: Toshiaki Komatsu, Commerce Township, MI (US)

(21) Appl. No.: 18/820,371

(22) Filed: Aug. 30, 2024

Related U.S. Application Data
(60) Provisional application No. 63/538,865, filed on Sep. 18, 2023.

(51) Int. Cl. F16D 27/14; H02K 7/108

(52) U.S. Cl. CPC F16D 27/14; H02K 7/1085; H02K 33/02

(57) ABSTRACT

A solenoid assembly for a rotary power transmission device, includes a core having an interior cavity, a wire coil received within the interior cavity, and at least one wire via which electricity is provided to the wire coil. A connection between the at least one wire and the wire coil is located within the interior cavity.

### REFERENCE TO RELATED APPLICATIONS

This application claims the benefit of U.S. Provisional Application Ser. No. 63/538,865 filed on Sep. 18, 2023 the entire content of which is incorporated herein by reference in its entirety.

### TECHNICAL FIELD

The present disclosure relates generally to a drivetrain component including an electromagnetic actuator with an integrated wire connection.

### BACKGROUND

Electromagnetic actuators selectively energize a wire coil to generate an electromagnetic field to drive a component from one position to another. Electricity is supplied to the coil via a wiring harness having a first electrical connector body that is connected to and extends outwardly from the coil and a second electrical connector body at the opposite end of wires that extend between the connector bodies. The electrical connection between the wiring harness and the coil is located outside of the coil and outside of components in which the coil is received. The exterior electrical connection and connector body extending from the coil is bulky, can be difficult to seal against contaminants and can lead to movement of the coil and a housing of the coil.

### SUMMARY

In at least some implementations, a solenoid assembly for a rotary power transmission device, includes a core having an interior cavity, a wire coil received within the interior cavity, and at least one wire via which electricity is provided to the wire coil. A connection between the at least one wire and the wire coil is located within the interior cavity.

In at least some implementations, a coil housing is provided surrounding the wire coil and received within the interior cavity. In at least some implementations, the connection is located within the coil housing. In at least some implementations, the coil housing includes an opening through which at least one of the at least one wires extends and is connected to the wire coil.

In at least some implementations, a bushing engages the at least one wire and the coil housing. In at least some implementations, the bushing also engages the core. In at least some implementations, the core includes an opening through which at least one of the at least one wire extends, and wherein the bushing is received at least partially within the opening and engages the core within the opening. In at least some implementations, the bushing engages a surface of the core that defines the interior cavity. In at least some implementations, the bushing engages a surface of the core to inhibit rotation of the coil housing.

In at least some implementations, the at least one wire is part of a wiring harness having multiple wires connected to a connector body at a first end of the wires, and wherein a second end of at least one of the at least one wire extends into an opening in the core.

In at least some implementations, the coil housing includes a projection adapted to inhibit rotation of the coil housing.

In at least some implementations, a solenoid assembly for a rotary power transmission device, includes a core having an interior cavity, a wire coil received within the interior cavity, a coil housing surrounding the wire coil, the coil housing is received within the interior cavity and between the wire coil and the core, and at least one wire via which electricity is provided to the wire coil. A connection between the at least one wire and the wire coil is located within the coil housing.

In at least some implementations, the coil housing includes a coil housing opening through which at least one of the at least one wires extends and is connected to the wire coil, and the core includes a core opening aligned with the coil housing opening.

In at least some implementations, a bushing received at least partially in the coil housing opening and engaging the at least one wire and the coil housing. In at least some implementations, a bushing engaged with the coil housing and received at least partially within the core opening and engaging the core within the core opening.

In at least some implementations, the bushing engages a surface of the core that defines the interior cavity.

In at least some implementations, the at least one wire is part of a wiring harness having multiple wires connected to a connector body at a first end of the wires, and wherein a second end of at least one of the at least one wire extends into an opening in the core.

In at least some implementations, the coil housing includes a projection at least partly received within a void in the core to inhibit rotation of the coil housing relative to the core.

### BRIEF DESCRIPTION OF THE DRAWINGS

The following detailed description of preferred embodiments and best mode will be set forth with reference to the accompanying drawings, in which:

FIG. 1 is a cross-sectional view of a differential with an electrically actuated clutch, wherein the differential is shown in a disengaged position/disconnected state;

FIG. 2 is a plan view of a coil housing and core with an integrated wiring harness connection;

FIG. 3 is a sectional view of a portion of the coil housing and wiring harness of FIG. 2;

FIG. 4 is a sectional view of the coil housing and core showing a connection of the wiring harness within the coil housing and with a lead wire of the wiring harness extending through a radially oriented opening in the core;

FIG. 5 is a sectional view of the coil housing and core showing a connection of the wiring harness within the coil housing and with a lead wire of the wiring harness extending through an axially oriented opening in the core;

FIG. 6 is a sectional view of the coil housing and core showing a connection of the wiring harness within the coil housing and with a lead wire of the wiring harness extending through a radially oriented opening in the core, and with an anti-rotation projection provided on the coil housing;

FIG. 7 is a partial plan view of the coil housing and core of FIG. 6 showing the anti-rotation projection located in a cavity of the core;

FIG. 8 is a sectional view of the coil housing and core showing a connection of the wiring harness within the coil housing and with a lead wire of the wiring harness extending through an axially oriented opening in the core, and with an anti-rotation projection provided on the coil housing;

FIG. 9 is a sectional view of the coil housing and core showing a connection of the wiring harness within the coil housing and with a lead wire of the wiring harness extending through a radially oriented opening in the core, with a bushing coupled to the coil housing and extending radially into an opening of the core;

FIG. 10 is a sectional view of the coil housing and core showing a connection of the wiring harness within the coil housing and with a lead wire of the wiring harness extending through an axially oriented opening in the core, with a bushing coupled to the coil housing and extending axially into an opening of the core;

FIG. 11 is a sectional view of the coil housing and core showing a connection of the wiring harness within the coil housing and with a lead wire of the wiring harness extending through a radially oriented opening in the core, with a bushing integrated into the coil housing with a projection of the coil housing extending radially into an opening of the core;

FIG. 12 is a sectional view of the coil housing and core showing a connection of the wiring harness within the coil housing and with a lead wire of the wiring harness extending through an axially oriented opening in the core, with a bushing integrated into the coil housing with a projection of the coil housing extending axially into an opening of the core; and

FIG. 13 is a plan view of a prior art coil housing and core with a wiring harness coupled thereto.

### DETAILED DESCRIPTION

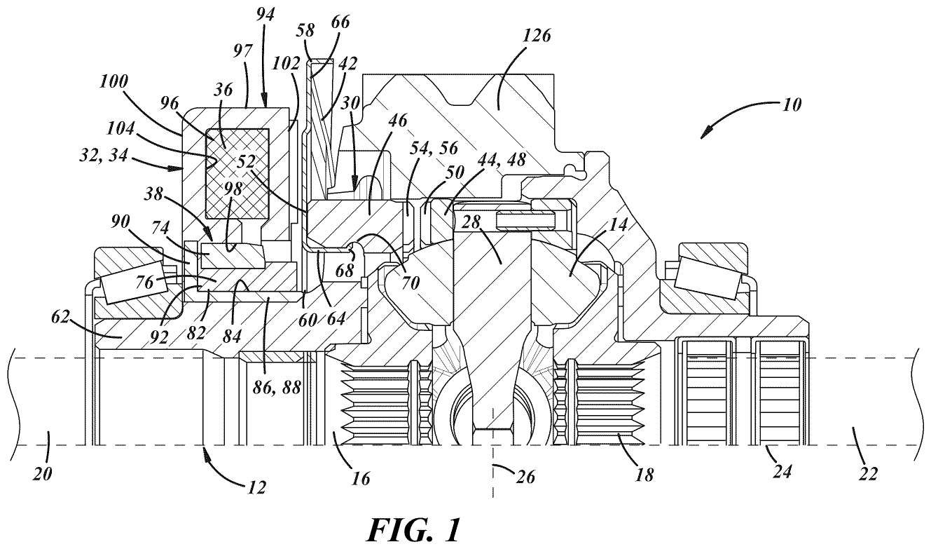

Referring in more detail to the drawings, FIG. 1 illustrates a portion of a drive train component, namely, a differential 10 such as may be used in an e-axle (e.g. an e-motor driven final drive unit, or any drive assembly). The differential 10 includes an outer housing 12, two or more pinion gears 14 (only one shown in FIG. 1), and a pair of side gears 16, 18 that are arranged to be coupled to rotating shafts 20, 22 that may drive, for example, wheels of a vehicle. Thus, the side gears 16, 18 rotate with the shafts 20, 22 about a shaft axis 24 and the pinion gears 14 are rotatable about an axis 26 defined by a pinion gear shaft 28 extending through the pinion gears.

The differential 10 also includes a clutch assembly 30 that is driven by an actuator 32 having a solenoid assembly 34 with an annular wire coil 36 and a drive member that may include an armature or plunger 38 that may be received at least partially radially inwardly of and axially overlapped with the coil 36. In at least some implementations, the plunger 38 is also annular, the plunger and coil 36 are coaxially arranged about axis 24 and are carried by the outer housing 12 of the differential 10 for rotation with the outer housing 12. One shaft 20 extends coaxially through a portion of the housing 12 that extends through the coil 36 and plunger 38. Electric power is supplied to the coil 36 to generate a magnetic field that displaces the plunger 38 relative to the coil 36 and outer housing 12 from a first or retracted position to a second or advanced position. To facilitate return of the plunger 38 from the second position back to the first position when power is not provided to the coil 36, a biasing member, such as a spring 42 may act on the plunger 38, or on a component engaged with the plunger, as set forth below. In at least some implementations, the clutch assembly 30 is engaged when the plunger 38 is in the second position and the clutch assembly 30 is disengaged when the plunger 38 is in the first position. While in the example shown the plunger 38 is in its second position when power is provided to the coil 36 and the plunger 38 moves to the first position when power is not supplied to the coil 36, the opposite could be true if desired (e.g. the clutch assembly 30 could be moved to the engaged position by the biasing member 42 and disengaged by powering the coil 36).

In at least some implementations, the clutch assembly 30 is an engaging clutch such as a dog clutch, and includes a first clutch member 44 that is not movable in an axial direction (defined by the central axis 24 of the plunger), and a second clutch member 46 that is movable in the axial direction relative to the first member 44.

In at least some implementations, the clutch assembly 30 may be used, for example, in a so-called free running differential 10, that selectively interrupts and permits torque transmission therethrough. In this device, a first rotating body is the outer differential housing 12 and a second rotating body is an inner housing 48, and the first rotating body and the second rotating body rotate about a common rotational axis 24. The inner housing 48 includes clutch teeth or, as in the implementation shown, the inner housing 48 is connected to the first clutch member 44 that includes the clutch teeth 50. In the example shown, the first clutch member 44 is coupled to the pinion gear shaft 26 and is constrained against axial movement relative to the second clutch member 46.

The second clutch member 46 may be coaxial with the axis 24 of the plunger 38, and may be received outboard of the pinion gear 14 (i.e. farther from the axis 24 than the pinion gear 14). The second clutch member 46 may include a rear face 52 closer to the plunger 38 than a front face 54, with the front face 54 having at least one engagement feature, such as gear or clutch teeth 56 (e.g. dog clutch teeth) configured to engage a corresponding engagement feature (e.g. gear or dog clutch teeth 50) formed on the first clutch member 44.

In at least some implementations, the second clutch member 46 may be connected to a carrier 58. The carrier 58 may radially position the second clutch member 46 and/or provide a radially outer surface that is detected by a suitable sensor to enable detection of the position of the second clutch member 46 (and hence, determination of the state of the clutch 30), as desired. In the implementation shown, the carrier 58 is annular and includes a central opening 60 received over a tubular portion 62 of the outer housing 12 about which the plunger 38 is received. An axially extending support may be defined by an annular flange 64, or spaced apart fingers radially spaced from the opening 60, to connect the carrier 58 to the second clutch member 46 at a location radially spaced from the tubular portion 62 of the outer housing 12, in at least some implementations. The second clutch member 46 may be trapped between a first face 66 of the carrier 58 adjacent to the rear face 52 of the second clutch member 46 and a radially bent end 68 of the support surface 64 that engages a radially extending surface of the second clutch member 46, shown as being defined in a groove 70 formed in a radially inner surface of the second clutch member 46. In this way, the carrier 58 and second clutch member 46 move together in both directions of movement of the second clutch member 46. The carrier may include a radially oriented flange arranged to be engaged by the plunger 38 during at least a portion of the stroke or range of movement of the plunger.

The spring 42 may be retained by and act on the first face 66 of the carrier 58 to bias second clutch member 46 to a retracted position in which the second clutch member teeth 56 are not meshed with the first clutch member teeth 50. The spring 42 may be received between a portion of the outer housing 12 and a portion of the carrier 58 and may be located radially inwardly or radially outwardly of the second clutch member 46, or both (e.g. more than one spring may be provided). Like the coil 36 and plunger 38, the second clutch member 46 also is carried by and rotates with the outer housing 12.

The plunger 38 may be formed from multiple materials including a material that is magnetically responsive to the magnetic field generated by the coil 36, and at least one other material that may or might not be responsive to the magnetic field. Thus, when the magnetic field is generated by the coil 36, the plunger 38 may be driven from one position to another (e.g. from the retracted to the advanced position). As used herein, a material is responsive to a magnetic field if a magnetic field of the magnitude generated by a solenoid 34 of the type used in applications such as that described herein, may cause a component formed of or including such material to be displaced.

In at least some implementations, the plunger 38 includes a main body with a central axis that may be coaxial with axis 24, and the plunger 38 may be defined by a first body 74 and a second body 76 that are coupled together and move as one unit or component and are not separated during use. The first body 74 may be formed from a magnetically responsive material and may be received adjacent to and radially inwardly of the coil 36, with a small air gap between them. The second body 76 may have at least a portion that is radially inward of at least a portion of the first body 74. The second body 76 may be annular and may, in at least some implementations, radially overlap part of the first body 74. The second body 76 may be conveniently overmolded onto the first body 74 to facilitate forming the second body and connecting together the first and second bodies, however other forming processes such as but not limited to casting, stamping or extruding may be used.

The second body 76 may be formed from a material that is not magnetically responsive (e.g. plastic, aluminum, stainless steel, etc.), and may provide a magnetic flux shield of sorts that improves the magnetic field strength on or in the area of the first body 74 to ensure proper response of the plunger 38 when the coil 36 is energized. In this way, the magnetic field is more concentrated or stronger in the area of the first body 74 to increase the magnetic flux at or in the first body and improve the responsiveness of the plunger 38 to the generated magnetic field.

The second body 76 may have an inner surface 82 that may define a pilot diameter for receipt of the plunger 38 over an annular surface 84 for guided linear, axial movement of the plunger 38 relative to the differential housing 12. In at least some implementations, the housing surface 84 may be defined by a plunger guide 86 received over the tubular extension of the housing 12. The plunger guide 86 may include an axially extending portion 88 with an outer surface that defines at least part of the surface 84, and a radially extending portion 90 adjacent to a rear face 92 of the plunger 38 (i.e. the face or side farthest from the second clutch member 46) and which may limit movement of the plunger 38 in that direction.

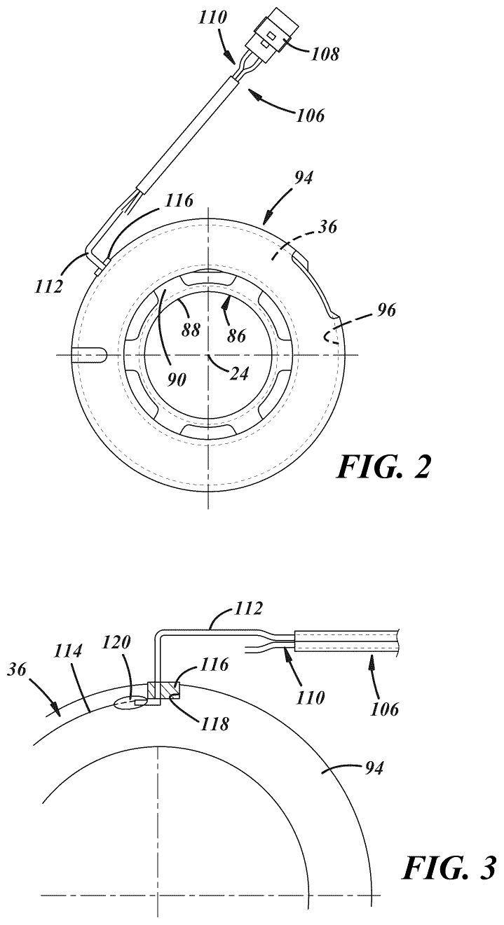

As shown in FIGS. 1 and 2, the solenoid assembly 32 may include a core 94 that may be formed of metal and which defines part of a magnetic flux path of the solenoid assembly 32, to actuate the plunger 38. The core 94 has a center axis which may be coaxial with the axis 24, an axially oriented outer surface 97, an axially oriented inner surface 98, a radially oriented outer end face 100 and an opposite, radially oriented inner end face 102. The core 94 may include or be coupled to the plunger guide 86 adjacent to but spaced from the inner surface 98, and by which the core may be mounted to the differential housing 12, as generally shown in FIG. 1. The core 94 may be formed from multiple metal pieces that are connected together and which define an interior cavity 104 in which the coil 36 is received.

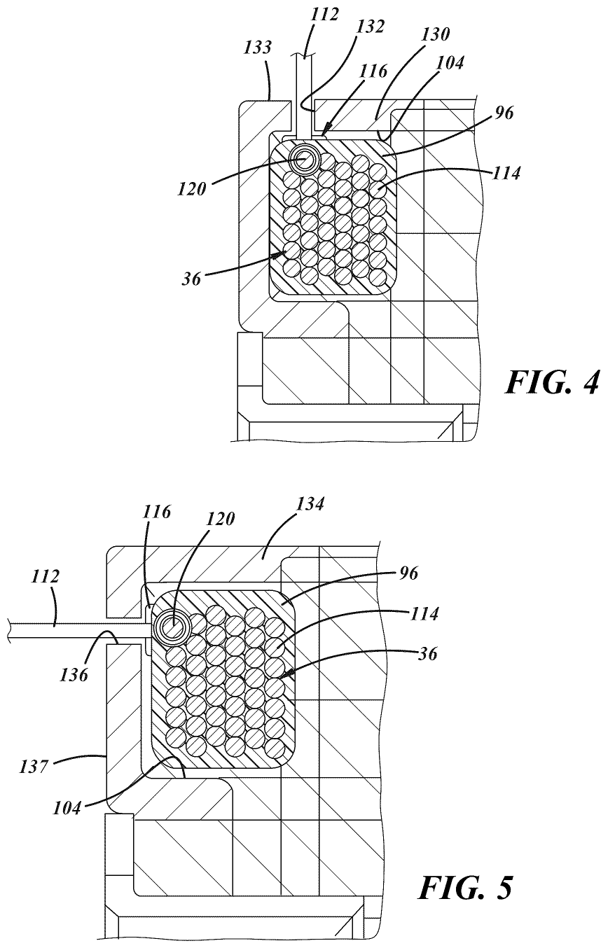

In at least some implementations, the coil 36 is received within a housing 96 that also is received within the interior cavity 104 of the core 94, and which may electrically isolate the coil 36 from the core 94. The housing 96 may be made from any suitable material such as various plastics. The housing 96 may be formed from more than one piece to facilitate assembly of the coil 36 into the housing 96, the housing may be molded over the coil, as shown in the examples of FIGS. 4-12, and the housing may be annular and may completely enclose the coil, if desired.

In FIG. 1, the differential 10 is shown with the clutch 30 in a disengaged position. In the illustrated implementation, in the disengaged position of the clutch 30, the coil 36 is not powered, the plunger 38 is in its first position (i.e. retracted position) and the second clutch member 46 is not engaged with the first clutch member 44 (that is, second clutch member teeth 56 are not meshed with the first clutch member teeth 50). In the disconnected position, the shafts/axles 20, 22 are not actively driven and may rotate relative to the second clutch member 46 and outer housing 12.

To change the clutch 30 from the disengaged position to the engaged position, the coil 36 is powered to generate a magnetic field that drives the plunger 38 its second position (i.e. advanced position) in which the plunger engages the central portion 60 of the carrier 58 and drives the second clutch member 46 into engagement with the first clutch member (i.e. teeth 58 engage and mesh with teeth 50). In this position, the inner housing 48 is coupled to and rotates with the outer housing 12 and torque is transmitted to the axles 20, 22.

FIG. 2 illustrates the core 94, coil housing 96 and a wiring harness 106 that is connected to the coil 36 to provide electrical power to the coil. The wiring harness 106 includes an electrical connector 108 at a first end, and multiple wires 110 coupled to the electrical connector, including a lead wire 112 that is connected at its other end to the wire 114 (FIGS. 3, 4 and others) of the coil 36. As also shown in FIG. 3, a bushing 116 may be received within a small cavity or opening 118 in the core 94, and the lead wire 112 may extend through the bushing 116 which provides a fluid tight seal with the core 94 and the lead wire 112 to inhibit contaminants from entering the coil. The lead wire 112 may extend into the coil housing 96 and be directly connected to the wire 114 of the coil 36 at a joint or connection 120 which may be formed in any desired way, such as but not limited to, splicing, crimping, soldering, brazing, or welding.

In the prior solenoid assemblies 117, as shown in FIG. 13, a wiring assembly 119 includes a first electrical connector 121 at one end and a second electrical connector 122 at its other end, that is mounted to the core 94, requiring a large cavity 124 and the second electrical connector 122 protrudes radially outwardly from the core 123 a significant distance. Further, the second electrical connector 122 needed to be sealed to the core 123 to prevent contamination. The large cavity 124 needed in the core 123 reduced material in the magnetic flux path and thus reduced the energy available to drive the plunger. Further, the protruding second electrical connector 122 caused problems during assembly of the adjacent drivetrain components and required a ring gear 126 (FIG. 1) of the differential to be installed on the differential housing 12 before the solenoid core 123 is installed on the differential housing. The ring gear 126 is often installed by a different entity than that which makes and assembles the differential, so the solenoid core 123 would have to be shipped with the differential to the different entity and be installed after the ring gear 126 installation by the different entity. This increased the cost and complexity to assemble the system and increased the chance of damage to the solenoid assembly 117.

In the example shown in FIG. 3, the bushing 116 is provided at the radially outer surface 97 of the core 94, at least partly and up to entirely outboard of the interior cavity 104, and the lead wire 112 extends through the bushing 116 in a radial direction, relative to the center axis of the core 94 and coil 36. In the example shown in FIG. 4, the core 130 may include an opening 132 that extends radially from the interior cavity 104 through the outer surface 133 of core 130, and the lead wire 112 extends through the opening 132, in a generally radial direction. In this example, the bushing 116 is received within the interior cavity 104, and may engage the core 130 around the periphery of the opening 132 to seal the opening. An arrangement similar to that shown in FIG. 4 is shown in FIG. 5. In FIG. 5, the core 134 includes an opening 136 that extends axially from the interior cavity 104 through the outer end face 137 of core 134, and the lead wire 112 extends through the opening 136, in a generally axial direction. In this example, the bushing 116 is received within the interior cavity 104, and may engage the core 134 around the periphery of the opening 136 to seal the opening. In the examples of FIGS. 4 and 5, the area or point of connection 120 between the wire 114 of coil 36 and the lead wire 112 is located within the coil housing 96, in the area that includes the coil 36 and the connection area may be embedded in the coil 36.

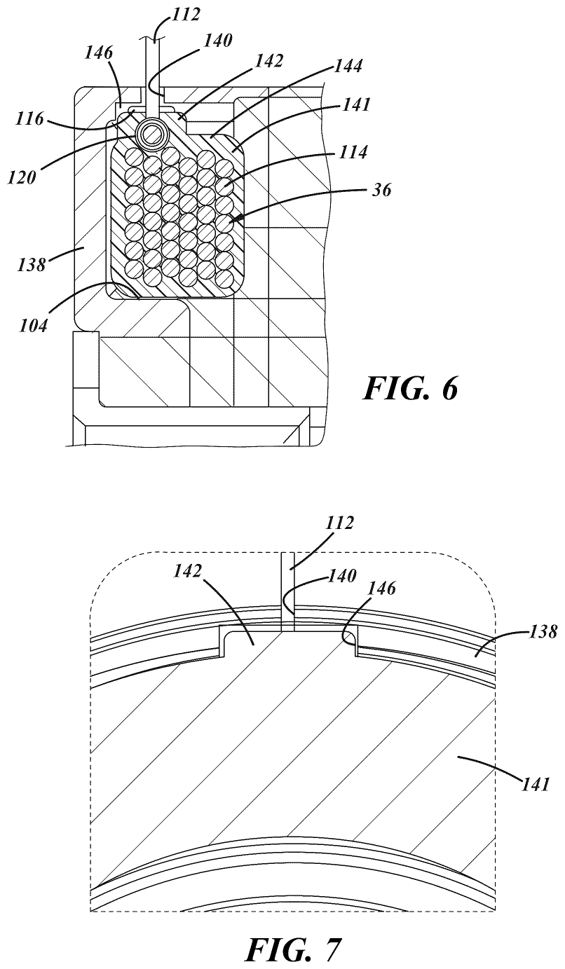

The example shown in FIGS. 6 and 7 is similar to that shown in FIG. 4, with a core 138 having a radially oriented opening 140 and the lead wire 112 extending radially into the interior cavity 104 for connection to the wire coil 36. In this embodiment, the coil housing 141 includes a projection 142 that extends radially outwardly from a radially outer surface 144 of the coil housing 141. The projection 142 may be received within a void 146 (e.g. slot) of the core 138, or against a stop surface of the core, to inhibit rotation of the coil housing 141. The bushing 116 may seal the opening 140 as described above and may be received in the projection 142 or between the projection 142 and core 138, within the interior cavity 104. In this example, the connection 120 between the wire 114 of the coil 36 and the lead wire 112 is within the projection 142 of the housing 141. That is, the connection 120 may be outboard of the area of the interior of the housing 141 in which wire 114 is received, but still within the housing 141, within the projection 142.

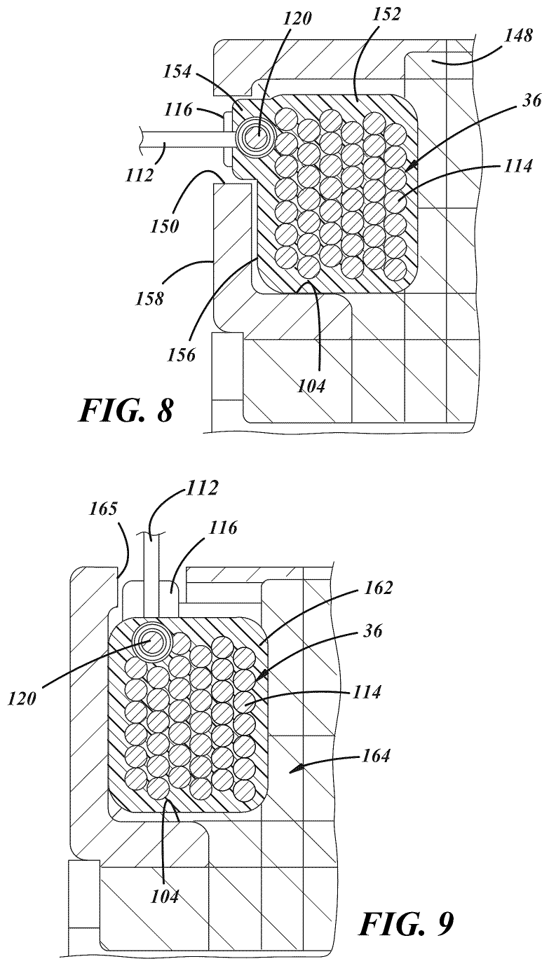

The example shown in FIG. 8 is similar to that shown in FIG. 5, with a core 148 having an axially oriented opening 150 and the lead wire 112 extending axially into the interior cavity 104 for connection to the wire coil 36. In this embodiment, and similar to the example shown in FIGS. 6 and 7, the coil housing 152 includes a projection 154, but this projection 154 extends axially outwardly from an axial end face 156 of the coil housing 152 that is adjacent to the outer end face 158 of the core 148. The projection 154 may be received at least partly within the opening 150 of the core 148, or against a stop surface of the core, to inhibit rotation of the coil housing 152. The bushing 116 may seal the opening 150 as described above and may be received in the projection 154 or between the projection and core, within the interior cavity 104. In this example, the connection 120 between the wire 114 of the coil 36 and the lead wire 112 is within the projection 154 of the housing 152. That is, the connection 120 may be outboard of the area of the interior of the housing 152 in which the coil 36 is received, but still within the housing 152, within the projection 154.

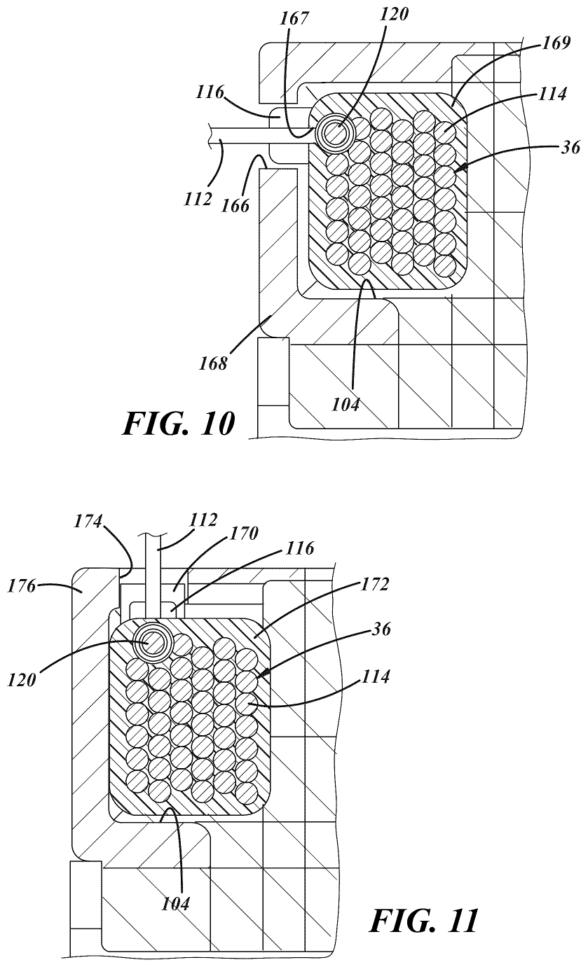

In the example shown in FIG. 9, instead of the radially oriented projection 154 of the coil housing 152 shown in FIGS. 6 and 7, the bushing 116 extends radially from an outer surface 160 of the coil housing 162. In this way, the bushing 116 may define a projection that may be used to limit rotation of the coil housing 162, and the bushing may also provide a seal against the wire 112 and the core 164 which includes opening 165. The example of FIG. 10 is similar to FIG. 9, but the bushing 116, opening 166 of core 168 and lead wire 112 are oriented axially, and an opening 167 in coil housing 169 through which the lead wire 112 is received may also be oriented axially.

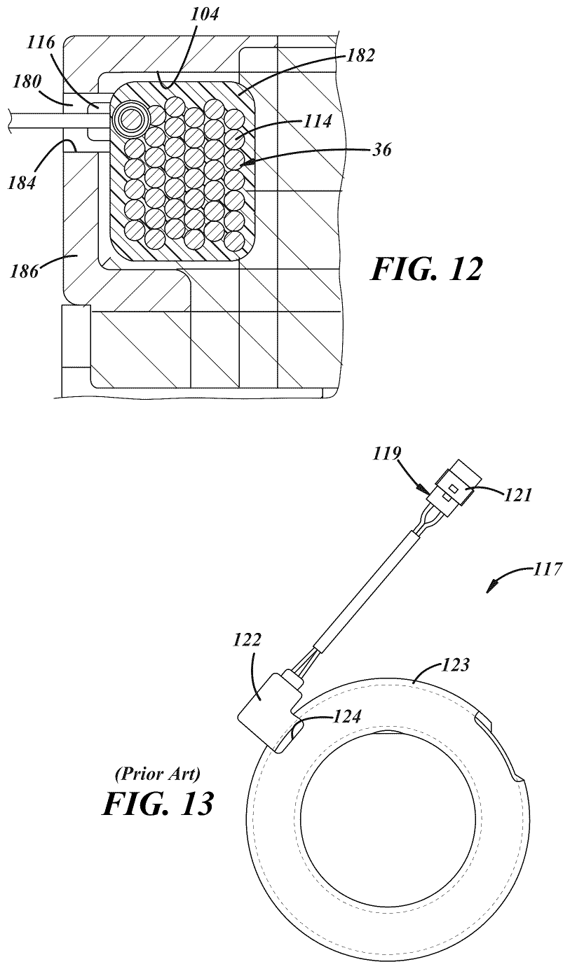

In the example shown in FIG. 11, a radially oriented projection 170 of the coil housing 172 seals the opening 174 of the core 176 through which the lead wire 112 is received, and the projection 170 may be partly received in the opening 174 in some embodiments. The bushing 116 may be received in the projection 170, such as by being overmolded in the housing 172 or inserted into the housing 172, and may provide seals with the coil housing 172 and the lead wire 112. In the example of FIG. 12, the projection 180 of the coil housing 182 is axially oriented, as is the opening 184 in the core 186 and the lead wire 112, and the bushing 116 may be received in the projection 180 and may provide seals with the coil housing 182 and the lead wire 112. In the examples of FIGS. 9-12, the connection 120 between the wire 114 of coil 36 and the lead wire 112 is located within the coil housing, and may be in the area including the coil 36, and within the boundaries of the coil 36.

In at least some implementations, the solenoid assemblies 32 include no electrical connector or housing connected to and protruding from the core, as in the conventional assembly shown in FIG. 13. Such a protruding body outside the core/housing assembly requires adjacent components to be designed to accommodate the protruding body, and for example, a housing of the differential needs additional space to avoid interference with the protruding body. Further, in the conventional design with the protruding body, the protruding body prevents the ring gear from being installed after the solenoid assembly is installed on the differential housing. Therefore, the ring gear has to be installed before the solenoid assembly is assembled to the differential housing, and this is often done by an entity assembling an axle assembly, which includes a gear that meshes with the ring gear, and not the entity who manufactures and assembles the differential. This requires separately shipping the differential and solenoid assemblies, and separate handling of these assemblies which increases the time, cost and complexity of assembly and can result in damage to the separately shipped and assembled components. Further, the protruding body requires a cavity in the core for mounting the protruding body on the core, and this leads to a loss of material in the magnetic flux path and a lower force on an armature of the solenoid which can increase the response time of the device.

In at least some implementations, such as the examples shown in FIGS. 2-12, the wire or very limited protrusion of a bushing or the like does not interfere with assembly of the ring gear to the differential housing, and does not require space to be provided in the differential housing or adjacent components which enables greater design freedom of the adjacent components and the entire solenoid assembly, including the core and coil/housing to be installed on the differential when the differential is being assembled. Further, the opening in the core provided for the lead wire to extend into the interior cavity can be smaller than the cavity needed for mounting the protruding body in the conventional design, which provides more material in the magnetic flux path and a stronger magnetic force output from the solenoid assembly and useful to drive the plunger.

Further, the wire connection between the wiring harness and the coil of the solenoid assembly can be contained within the core, such as within the interior cavity of the core, and/or within the coil housing that is within the interior cavity of the core. Previously, the coil included a wire end that extended out of the coil housing and which was connected to a wiring harness outboard of the interior cavity in which the coil housing was received. More particularly, the wire end was connected to the wiring harness within a second electrical connector body that was mounted to the core, as discussed above. With the wire connection occurring within the interior cavity of the core, a more compact core and solenoid assembly can be made that does not require an electrical connector or other body on the core. A bushing that surrounds part of the lead wire may be received within the interior cavity of the core, and may be received fully or partly within the coil housing. Still further, the coil housing may have more than one projection adapted to engage the core and limit or prevent rotation of the coil housing relative to the core.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A solenoid assembly for a rotary power transmission device, comprising:
a core having an interior cavity;
a wire coil received within the interior cavity;
at least one wire via which electricity is provided to the wire coil, wherein a connection between the at least one wire and the wire coil is located within the interior cavity.

2. The assembly of claim 1, which also includes a coil housing surrounding the wire coil and received within the interior cavity.

3. The assembly of claim 2 wherein the connection is located within the coil housing.

4. The assembly of claim 3 wherein the coil housing includes an opening through which at least one of the at least one wires extends and is connected to the wire coil.

5. The assembly of claim 2 which also includes a bushing engaging the at least one wire and the coil housing.

6. The assembly of claim 5 wherein the bushing also engages the core.

7. The assembly of claim 6 wherein the core includes an opening through which at least one of the at least one wire extends, and wherein the bushing is received at least partially within the opening and engages the core within the opening.

8. The assembly of claim 7 wherein the bushing engages a surface of the core that defines the interior cavity.

9. The assembly of claim 1 wherein the at least one wire is part of a wiring harness having multiple wires connected to a connector body at a first end of the wires, and wherein a second end of at least one of the at least one wire extends into an opening in the core.

10. The assembly of claim 2 wherein the coil housing includes a projection adapted to inhibit rotation of the coil housing.

11. The assembly of claim 5 wherein the bushing engages a surface of the core to inhibit rotation of the coil housing.

12. A solenoid assembly for a rotary power transmission device, comprising:
a core having an interior cavity;
a wire coil received within the interior cavity;
a coil housing surrounding the wire coil, the coil housing is received within the interior cavity and between the wire coil and the core;
at least one wire via which electricity is provided to the wire coil, wherein a connection between the at least one wire and the wire coil is located within the coil housing.

13. The assembly of claim 12 wherein the coil housing includes a coil housing opening through which at least one of the at least one wires extends and is connected to the wire coil, and the core includes a core opening aligned with the coil housing opening.

14. The assembly of claim 13 which also includes a bushing received at least partially in the coil housing opening and engaging the at least one wire and the coil housing.

15. The assembly of claim 13 which also includes a bushing engaged with the coil housing and received at least partially within the core opening and engaging the core within the core opening.

16. The assembly of claim 15 wherein the bushing engages a surface of the core that defines the interior cavity.

17. The assembly of claim 12 wherein the at least one wire is part of a wiring harness having multiple wires connected to a connector body at a first end of the wires, and wherein a second end of at least one of the at least one wire extends into an opening in the core.

18. The assembly of claim 12 wherein the coil housing includes a projection at least partly received within a void in the core to inhibit rotation of the coil housing relative to the core.

19. The assembly of claim 15 wherein the bushing engages a surface of the core to inhibit rotation of the coil housing.
